(19) United States
(12) Patent Application Publication
(10) Pub. No.: US 2026/0278311 A1
(43) Pub. Date: Sep. 17, 2026

(54) METHOD AND APPARATUS FOR PROVIDING AUTOMATIC TRANSLATION SERVICE

(71) Applicant: XL8AI Co., Ltd., Daejeon (KR)

(72) Inventors: Dong Hyun KIM, Seoul (KR); Sang Eun Lee, Seoul (KR)

(21) Appl. No.: 19/563,351

(22) Filed: Mar. 11, 2026

(30) Foreign Application Priority Data
Mar. 12, 2025 (KR) 10-2025-0032031

(51) Int. Cl. G06F 40/58; G06F 16/951

(52) U.S. Cl. CPC G06F 40/58; G06F 16/951

(57) ABSTRACT

Disclosed is a translation service providing method. The disclosed method includes acquiring user information; extracting domain information related to a user from the user information; collecting at least one webpage related to the domain information; and building a glossary for user-customized translation by analyzing at least one webpage related to a domain.

### CROSS-REFERENCE TO RELATED APPLICATION(S)

This application claims priority from Korean Patent Application No. 10-2025-0032031, filed on Mar. 12, 2025, the entire contents of which are hereby incorporated by reference.

### BACKGROUND

### 1. Field

The following description of the present disclosure relates to a method and device for providing an automatic translation service, and more specifically, to a method and device for providing an automatic translation service by building a user-specific glossary to provide a customized translation to a user.

### 2. Related Art

With the recent growing demand for multilingual translation and interpretation in a global business environment, machine translation and artificial intelligence (AI)-based translation systems are being actively researched and developed. In particular, translation services, such as Google Translate, DeepL, and Papago, are leveraging neural machine translation (NMT) technology to improve the translation quality.

However, the existing translation systems operate by learning general translation data (corpus), so have the limitation in translating terms specified to a specific company or industry. For example, when the term ‘Apple (EN)’ is recognized as a common noun, it may be translated as ‘ [symbol] (KO)’ that indicates apple, but when it is recognized as a corporate name, it may be translated as ‘ [symbol] (KO)’ that indicates the corporate name. In addition to the aforementioned case, a technical term may be translated differently depending to a use entity. For example, ‘Mobile communication (EN)’ may be translated in various manners, such as ‘ [symbol] (KO),’ ‘ [symbol] (KO),’ and ‘ [symbol] (KO),’ depending on the use entity. Also, ‘Terminal (EN)’ has various translation options, such as ‘ [symbol] (KO),’ ‘ [symbol] (KO),’ and ‘ [symbol] (KO),’ depending on the context or the industrial field.

To improve the consistency and accuracy of translation, a method called glossary that compiles frequently used terms in the specific industry is being used. For example, analyzing documents used in the specific industry to build a customized glossary and to apply the same for translation may lead to more accurate translation.

However, in order to build such a glossary, a user must manually input terms or directly provide analysis data required during the glossary construction process, which is cumbersome.

### SUMMARY

The present disclosure is conceived in response to the aforementioned background, and aims to provide a customized translation by automatically building a glossary suitable for a user.

Technical objects set forth herein are not limited to the aforementioned technical objects and other technical objects not described herein may be clearly understood by one of ordinary skill in the art from the following description.

According to an aspect of at least one example embodiment, there is provided a translation service providing method performed by a computing device including a processor and a communication unit. The disclosed method includes acquiring user information; extracting domain information related to a user from the user information; collecting at least one webpage related to the domain information; and building a glossary for user-customized translation by analyzing at least one webpage related to the domain information.

The user information may include information on at least one of an email account of the user, a social networking service (SNS) of the user, a homepage of the user, and a cloud service account of the user.

The at least one webpage may include at least one of a homepage, a blog, and a social media page related to the domain of the user.

The building of the glossary may include extracting a proper noun from the at least one webpage; and adding the extracted proper noun to the glossary.

The building of the glossary may include extracting, from the at least one webpage, a term that satisfies a condition on at least one of appearance frequency and appearance count; and adding the extracted term to the glossary.

The building of the glossary may include extracting information on a usage language of the user from the at least one webpage; and adding information on the usage language of the user to the glossary.

At least one of a source language and a target language of translation may be determined based on information on the usage language of the user that is included in the glossary.

The translation service providing method may further include providing translation from a source language to a target language based on a translation request. The translation may be provided by reflecting the glossary.

Unification of terms and priority adjustment of terms used in the target language may be performed by reflecting the glossary in a process of providing the translation.

When the glossary includes a term written in the target language, the term included in the glossary may be preferentially reflected in a translated result.

The building of the glossary may include when the at least one webpage includes a page written in a first language and a page written in a second language different from the first language, extracting a first term from the page written in the first language; extracting a second term corresponding to the first term from the page written in the second language; and adding the first term and the second term to the glossary by associating the first term with the second term.

When the first language is set as a source language, a third language is set as a target language, and the second language is set as an intermediate language in a process of providing the translation, a mapping relationship between the first term and the second term may be considered in a translation process between the source language and the intermediate language.

The translation service providing method may further include performing monitoring on at least one webpage related to the domain information; and when a change in the at least one webpage related to the domain information is reflected by monitoring, updating the glossary by analyzing the changed content.

Further areas of applicability will become apparent from the description provided herein. The description and specific examples in this summary are intended for purposes of illustration only and are not intended to limit the scope of the present disclosure.

### Effect

According to at least one example embodiment, it is possible to prevent mistranslation for technical terms, corporate brands, and product names by building a customized glossary specified for a user.

According to at least one example embodiment, it is possible to maintain consistency of translation by using consistent terminology through a translation process.

According to at least one example embodiment, since a translation service providing device automatically builds a glossary based on domain information of a user, it is possible to save the cost and time used for a glossary building process.

According to at least one example embodiment, it is possible to continuously improve the translation quality by automatically reflecting changes in a webpage through monitoring of the webpage and thereby updating a glossary.

### BRIEF DESCRIPTION OF THE FIGURES

Various aspects are described with reference to the accompanying drawings and, herein, like reference numerals refer to like elements throughout. In the following example embodiments, numerous specific details are set forth herein to provide thorough understanding of at least one aspect for the purpose of explanation. However, it will be apparent that such aspect(s) may be practiced without the specific details. In other examples, known structures and devices are illustrated in a form of a block diagram to easily describe at least one aspect:

FIG. 1 is a diagram illustrating a translation service providing device according to an example embodiment;

FIG. 2 is a flowchart illustrating a translation service providing method according to an example embodiment;

FIG. 3 is a conceptual diagram illustrating a process of performing operations S120 and S130 of FIG. 2;

FIG. 4 is a flowchart illustrating a process of performing operation S140 of FIG. 2;

FIG. 5 is a flowchart illustrating a process of performing operation S140 of FIG. 2;

FIG. 6 is a conceptual diagram illustrating an example of a schema of a glossary; and

FIG. 7 is a flowchart illustrating a glossary update process according to an example embodiment.

### DETAILED DESCRIPTION

Various modifications and changes may be made to the present invention and the present invention may include various example embodiments. Specific example embodiments are described in detail with reference to the accompanying drawings. The example embodiments, however, may be embodied in various different forms, and should not be construed as being limited to only the specific example embodiments. Rather, the example embodiments should be understood to include all of the modifications, equivalents, and substitutions included in the spirit and technical scope of the present invention. Like reference numerals refer to like elements throughout to describe each drawing.

Although the terms “first,” “second,” “A,” “B,” etc., may be used herein to describe various components, the components should not be limited by these terms. These terms are only used to distinguish one component from another component. For example, a first component may also be termed a second component and, likewise, a second component may be termed a first component, without departing from the scope of the present invention. As used herein, the term “and/or” includes any and all combinations of one or more of the listed items.

When a component is referred to as being “connected to” or “accessed to” another component, the component may be directly connected to or accessed to the other component, or one or more other intervening components may be present. In contrast, when a component is referred to as being “directly connected to” or “directly accessed to,” there is no intervening component.

The terms used herein are used to simply explain specific example embodiments and are not construed to limit the present invention. The singular forms “a,” “an,” and “the,” are intended to include the plural forms as well, unless the context clearly indicates otherwise. It will be further understood that the terms “comprises/comprising (includes/including),” and “has/having” when used in this specification, specify the presence of stated features, integers, steps, operations, elements, and/or components, but do not preclude the presence or addition of one or more other features, integers, steps, operations, elements, components, and/or groups, thereof.

Unless otherwise defined, all terms including technical and scientific terms used herein have the same meaning as commonly understood by one of ordinary skill in the art to which the present invention pertains. Terms, such as those defined in commonly used dictionaries, should be interpreted as having a meaning that is consistent with their meaning in the context of the relevant art, and should not be interpreted in an idealized or overly formal sense unless expressly so defined herein.

Herein, the term ‘translation’ may be interpreted to include translation and interpretation. Typically, interpretation may indicate changing a language and conveying the same orally, and translation may indicate changing a language and conveying the same in writing. However, herein, ‘translation’ encompasses interpretation and translation for convenience of understanding, and may indicate converting first language-based content to second language-based content. For example, ‘translation’ may indicate converting a first language-based speech signal to second language-based speech or text. As another example, ‘translation’ may indicate first language-based text to second language-based speech or text.

Herein, ‘glossary’ refers to a type of terminology used to improve the quality of translation, and may include information on a plurality of terms. ‘Glossary’ may be used to provide consistent translation and user-customized translation.

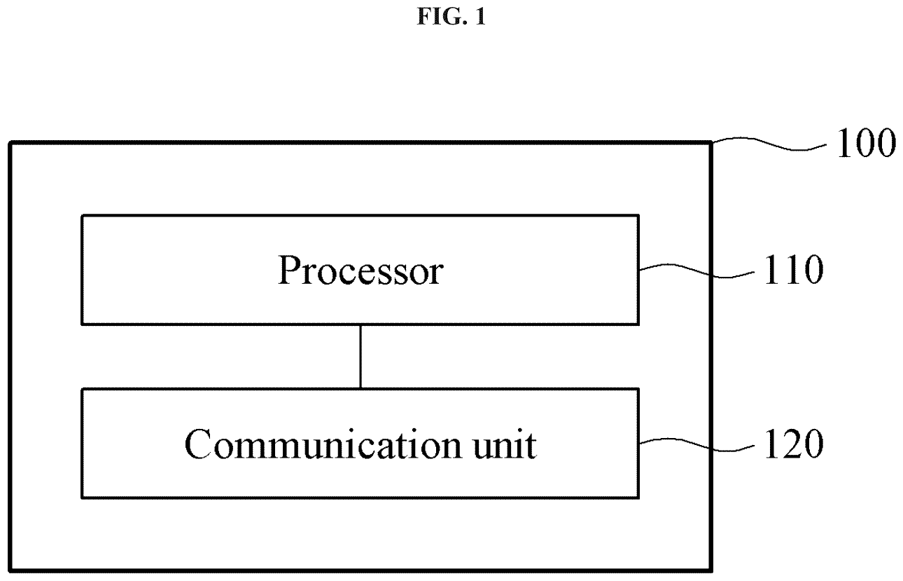

FIG. 1 is a conceptual diagram illustrating a translation service providing device according to an example embodiment.

Referring to FIG. 1, a translation service providing device 100 may achieve the desired system performance using a combination of typical computer hardware (e.g., a device that may include a computer processor, a memory, a storage, an input device and an output device, and components of other existing computing devices; an electronic communication device, such as a router and a switch; an electronic information storage system, such as a network-attached storage (NAS) and a storage area network (SAN)), and computer software (i.e., instructions that allow a computing device to operate in a specific manner).

The translation service providing device 100 may be connected to another computing device over a network. The network refers to a network that connects the above components, and includes a wired network, a wireless network, and the like. The network may be a closed network, such as a local area network (LAN) and a wide area network (WAN), or an open network, such as the Internet. The Internet refers to a global open computer network structure that provides a TCP/IP protocol and various services present in an upper layer thereof, that is, HyperText Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), and Network Information Service (NIS).

The translation service providing device 100 may include a communication unit 120 and a processor 110. The communication unit 120 may communicate with the Internet network or another device through the network. The processor 110 may control the communication unit 120, and may process information acquired from the communication unit 120.

The processor 110 may include at least one core, and may include a processor for data analysis, such as a central processing unit (CPU), a general purpose graphics processing unit (GPGPU), a tensor processing unit (TPU), and the like.

The processor 110 may execute a program command stored in a memory. The memory may include at least one of read only memory (ROM) and random access memory (RAM). The processor 110 may control the communication unit 120, and may process information acquired from the communication unit 120. The communication unit 120 may be connected to the network, and may communicate with other nodes.

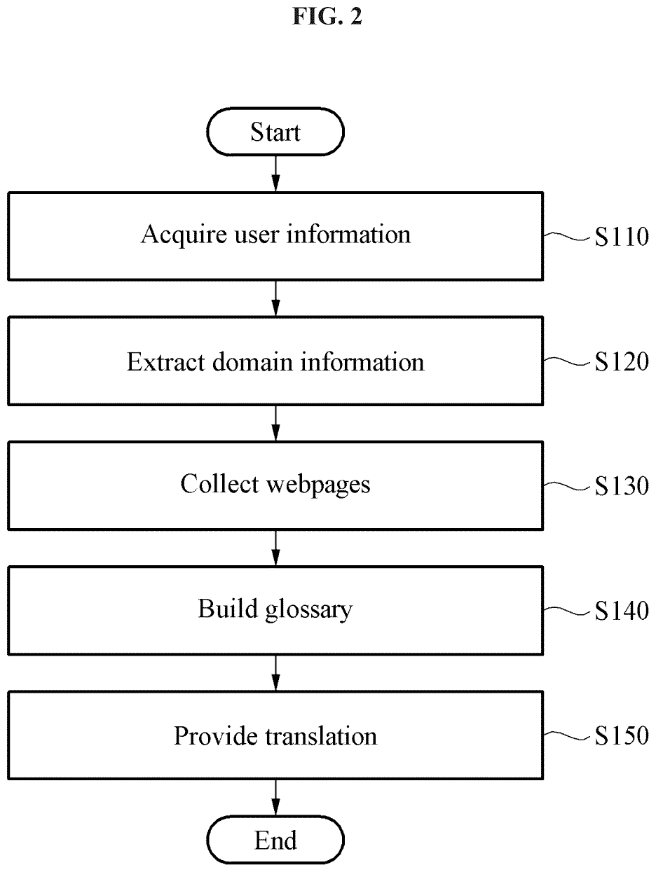

FIG. 2 is a flowchart illustrating a translation service providing method according to an example embodiment.

Referring to FIG. 2, in operation S110, the translation service providing device 100 may acquire user information. The user information may include information on a user that uses a translation service. The user information may include an email account of the user, a uniform resource locator (URL) of a specific webpage input from the user (e.g., homepage URL address of user), a social networking service (SNS) account, a cloud service or collaborative tool account used by the user (Google Workspace, Microsoft 365, Slack, Notion, etc.), and the like. The user information may be acquired in various manners. For example, the translation service providing device 100 may acquire user information based on subscription information input from the user in a translation service subscription procedure. As another example, the translation service providing device 100 may acquire the user information by providing a user interface that induces the user to input the user information.

In operation S120, the translation service providing device 100 may extract domain information related to the user from the user information. The domain information may be information on an Internet domain. For example, the translation service providing device 100 may extract domain information related to the user from email account information of the user. The translation service providing device 100 may extract the domain information from a webpage URL input from the user. The translation service providing device 100 may also acquire the domain information from cloud service or collaborative tool account information of the user. The translation service providing device 100 may acquire the domain information from an official SNS account of the user.

In operation S130, the translation service providing device 100 may collect webpages related to the corresponding domain information based on the extracted domain information. During a webpage collection process, the translation service providing device 100 may perform at least one of crawling, scanning, and scraping on primary webpages that use a specific domain. The translation service providing device 100 may explore a subdomain related to the extracted domain, and may collect webpages that use the subdomain.

The webpage related to the domain information may include a homepage, a blog, and social media that use a specific domain or are associated with the specific domain, but example embodiments are not limited thereto.

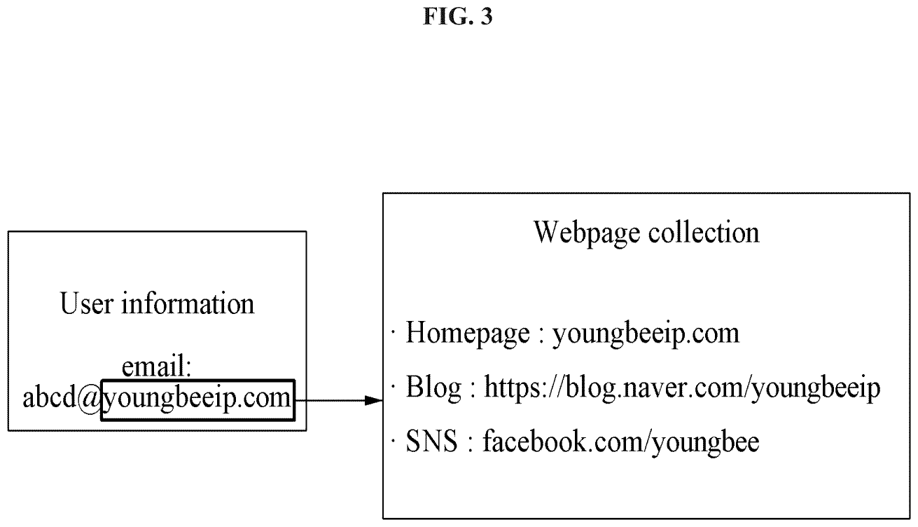

FIG. 3 is a conceptual diagram illustrating a process of performing operations S120 and S130 of FIG. 2.

Referring to FIG. 3, the translation service providing device 100 may verify the user's email account that is included in the user information or inferable from the user information. The translation service providing device 100 may extract domain information (youngbeeip.com) related to the user from the email account of the user. The translation service providing device 100 may extract the user's homepage, blog, and social media related to the domain information.

In operation S140, the translation service providing device 100 may build a user customized glossary by analyzing the collected webpages. The translation service providing device 100 may analyze the content of the collected webpages. The translation service providing device 100 may analyze the text of the webpage. The translation service providing device 100 may refine the text of the webpage. During a refining process, the translation service providing device 100 may filter out unnecessary elements, such as HTML tag and advertising content. The translation service providing device 100 may tokenize the refined text based on a sentence unit or a word unit. Also, the translation service providing device 100 may extract a proper noun or a technical term. The translation service providing device 100 may determine terms to be included in the glossary in consideration of the appearance frequency and appearance count of a specific term, the type of the corresponding term (proper noun or not), and the like.

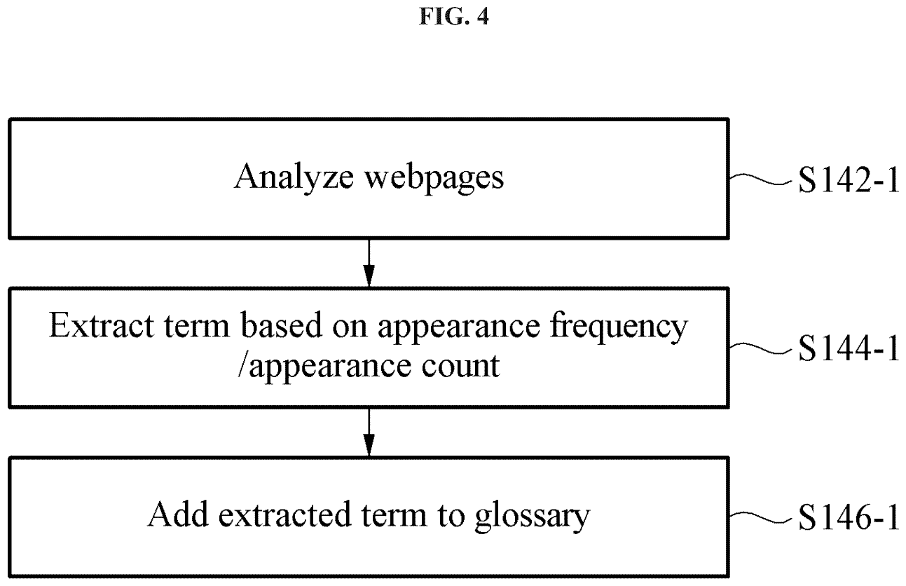

FIG. 4 is a flowchart illustrating a process of performing operation S140 of FIG. 2.

Referring to FIG. 4, in operation S142-1, the translation service providing device 100 may analyze the collected webpages. The translation service providing device 100 may analyze the language content of the webpage. For example, the translation service providing device 100 may analyze the text of the webpage. However, the example embodiment is not limited thereto. For example, the translation service providing device 100 may also analyze video or audio content disclosed in the webpage. The translation service providing device 100 may tokenize the refined text based on the sentence unit or the word unit during an analysis process. Also, the translation service providing device 100 may extract a proper noun or a technical term.

In operation S144-1, the translation service providing device 100 may determine a term to be reflected in the glossary based on at least one of the appearance frequency and the appearance count of the term in the webpage. For example, the translation service providing device 100 may add, to the glossary, a term of which appearance frequency on the webpage (e.g., number of appearances per a predetermined number of words) is greater than a predetermined reference value. As another example, the translation service providing device 100 may add, to the glossary, a term of which the total number of appearances in the webpage is greater than a predetermined reference value.

The translation service providing device 100 may differently set a reference value (reference value for appearance frequency or appearance count) to reflect to the glossary depending on the type of term. For example, the translation service providing device 100 may set a low reference value for a proper noun, or may directly reflect the same to the glossary without considering the reference value itself. For example, the translation service providing device 100 may apply a lower reference value to a term that is determined to be specialized for specific technology or industrial field, compared to general terms.

For example, terms, such as ‘backpropagation’ and ‘gradient descent,’ are specified to AI technology and may be reflected in the glossary although they have relatively low appearance frequency. Conversely, terms, such as ‘data’ and ‘computer,’ are general terms and may have a high reference value for addition to the glossary. However, even general terms may be added to the glossary if they have very high appearance frequency or appearance count.

In operation S146-1, the translation service providing device 100 may add the extracted terms to the glossary.

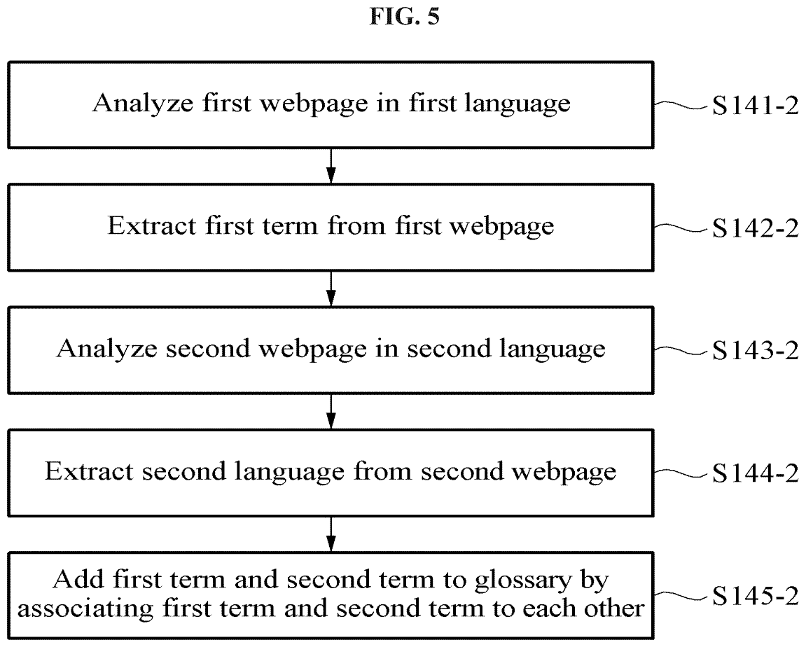

FIG. 5 is a flowchart illustrating a process of performing operation S140 of FIG. 2.

For example, a page related to a domain of the user may include pages written in two or more languages. For example, in relation to the domain of the user, there may be a homepage written in a first language (e.g., Korean) and a homepage written in a second language (e.g., English). When there are webpages written in two or more languages for the same content, the translation service providing device 100 may build the glossary by considering the correlation between two webpages.

Referring to FIG. 5, in operation S141-2, the translation service providing device 100 may analyze a first webpage based on the first language. The translation service providing device 100 may analyze first language-based text or first language-based audio or video.

In operation S142-2, the translation service providing device 100 may extract at least one first term to be reflected in the glossary from the first webpage. The translation service providing device 100 may extract the at least one first term by considering at least one of the appearance count of the term, the appearance frequency of the term, and the type of the term.

In operation S143-2, the translation service providing device 100 may analyze a second webpage based on the second language. The second language may differ from the first language. The translation service providing device 100 may analyze second language-based text or second language-based audio or video.

In operation S144-2, the translation service providing device 100 may extract at least one second term to be reflected in the glossary from the second webpage. The translation service providing device 100 may extract the at least one second term by considering at least one of the appearance count of the term, the appearance frequency of the term, and the type of the term.

In operation S145-2, the translation service providing device 100 may add the first term and the second term to the glossary by associating the first term and the second term to each other.

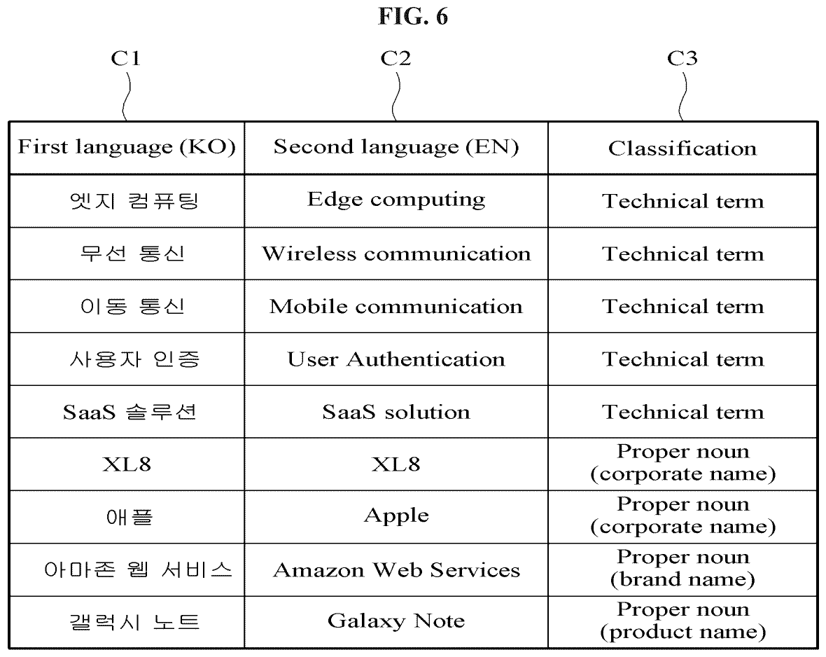

FIG. 6 is a conceptual diagram illustrating an example of a schema of a glossary.

Referring to FIG. 6, the glossary may include a first column (C1) that includes first terms based on a first language and a second column (C2) that includes second terms based on a second language. The glossary may further include a third column (C3) that includes information indicating classification of each of the terms. The classification of the terms may be utilized in a translation service providing process. In addition, the glossary may store the first terms based on the first language and the second terms based on the second language by associating them to each other. Therefore, the translation service providing device 100 may consider the mapping relationship between the first language and the second language when performing translation between the first language and the second language. For example, the translation service providing device 100 may consistently translate ‘ [symbol] ’ to ‘Wireless communication’ in KR->EN’ translation by considering the glossary. Also, the translation service providing device 100 may recognize ‘XL8’ as a proper noun, and may reflect ‘XL8’ to the translation result even in English->Korean translation.

The translation service providing device 100 may improve the translation quality using the mapping relationship between the first term and the second term. For example, when performing a translation in which a source language is a first language (Korean) and a target language is a third language (Chinese), the translation service providing device 100 may utilize a second language (English) as an intermediate language. In this case, the mapping relationship between the first term and the second term may be considered in an intermediate language translation process. The translation service providing device 100 may improve the translation quality from the first language to the second language in consideration of the mapping relationship between the first term and the second term shown in FIG. 6.

The translation service providing device 100 may further include additional information in the glossary in addition to the terms. For example, the translation service providing device 100 may identify a language used in a webpage related to the extracted domain. Based on this, the translation service providing device 100 may store information on language options preferred by the user by including the information in the glossary. Based on the language options preferred by the user, the translation service providing device 100 may set at least one of the source language and the target language of the translation. For example, when it is determined that the user uses Korean as the user's native language, the translation service providing device 100 may set the default settings of the target language to Korean. When it is determined that the user's business is highly related to Japan based on the result of analyzing the webpage related to the user, the translation service providing device 100 may set the default settings of the source language to Japanese.

Referring again to FIG. 2, in operation S150, the translation service providing device 100 may provide a translation service. The translation service providing device 100 may use the terms included in the glossary to ensure that terms in a field related to the user or proper nouns related to the user may be translated in a consistent manner in the translation. The translation service providing device 100 may provide a customized translation service by utilizing general translation data and the glossary together. For example, when there is a conflict between the general translation data and the glossary term, the translation service providing device 100 may preferentially reflect the term of the glossary in the translation. Also, the translation service providing device 100 may set default settings on at least one of the source language and the target language of the translation service based on information on the user's language or preferred language included in the glossary.

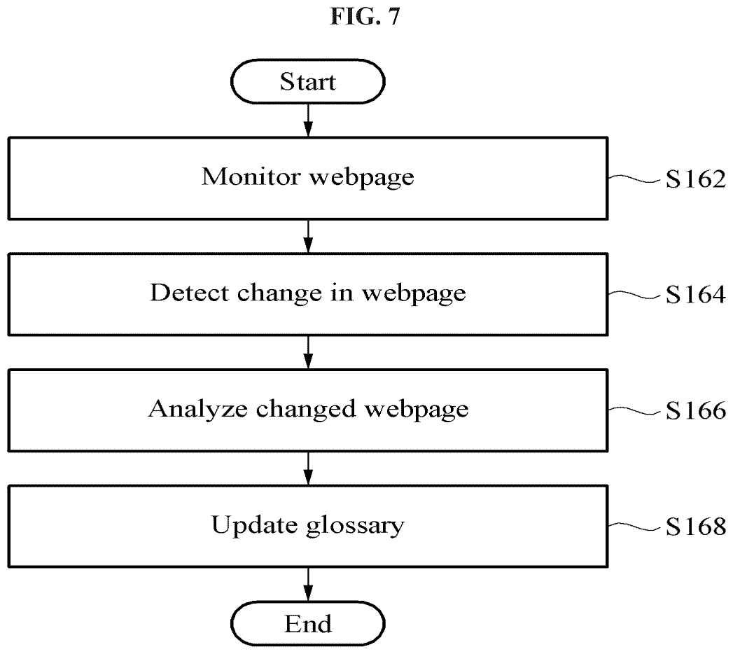

FIG. 7 is a flowchart illustrating a glossary update process according to an example embodiment.

Referring to FIG. 7, in operation S162, the translation service providing device 100 may monitor webpages associated with a domain of the user. Monitoring may be performed periodically according to a preset cycle. As another example, monitoring may be performed in response to a request from the user. As another example, when a predetermined trigger condition is satisfied, monitoring may be performed.

In operation S164, the translation service providing device 100 may verify whether there is a change in webpages already collected. Also, the translation service providing device 100 may further collect a new webpage associated with the domain of the user based on the monitoring.

In operation S166, the translation service providing device 100 may analyze a changed or newly generated webpage.

In operation S168, the translation service providing device 100 may update the glossary based on the analysis result. During the update process, a term in the glossary may be revised or deleted. Also, a new term may be added.

The translation service providing method and device according to example embodiments are described above with reference to FIGS. 1 to 7.

According to at least one example embodiment, it is possible to prevent mistranslation for technical terms, corporate brands, and product names by building a customized glossary specified for a user.

According to at least one example embodiment, it is possible to maintain the consistency of translation by using consistent terminology through a translation process.

According to at least one example embodiment, since a translation service providing device automatically builds a glossary based on domain information of a user, it is possible to save the cost and time used for a glossary building process.

According to at least one example embodiment, it is possible to continuously improve the translation quality by automatically reflecting changes in webpage through monitoring of the webpage and thereby updating a glossary.

The example embodiments described herein may be implemented using hardware components, software components, and/or combination of hardware components and software components. For example, the apparatuses, the methods, and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may permanently or temporarily be embodied in any type of machine, component, physical equipment, virtual equipment, computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions that may be performed through various computer devices and recorded in computer-readable media. The computer-readable media may include, alone or in combination with program instructions, data files, data structures, and the like. Program instructions stored in the media may be those specially designed and constructed for the example embodiments, or they may be well-known and available to those having skill in the computer software arts. Examples of the media include magnetic media such as hard disks, floppy disks, and magnetic tapes; optical media such as CD ROM and DVDs; magneto-optical media such as floptical disks; and hardware devices that are specially configured to store and perform program instructions, such as read-only memory (ROM), random access memory (RAM), flash memory, and the like. Examples of program instructions include a machine language code, such as that produced by a compiler, as well as a high-level language code that may be executed by a computer using an interpreter and the like. The hardware device may be configured to act as at least one software module for performing operations of example embodiments, or vice versa.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, or replaced or supplemented by other components or their equivalents.

What is claimed is:

1. A translation service providing method performed by a computing device comprising a processor and a communication unit, the translation service providing method comprising:
acquiring user information;
extracting domain information related to a user from the user information;
collecting at least one webpage related to the domain information; and
building a glossary for user-customized translation by analyzing at least one webpage related to the domain information.

2. The translation service providing method of claim 1, wherein the user information includes information on at least one of an email account of the user, a social networking service (SNS) of the user, a homepage of the user, and a cloud service account of the user.

3. The translation service providing method of claim 1, wherein the at least one webpage includes at least one of a homepage, a blog, and a social media page related to the domain of the user.

4. The translation service providing method of claim 1, wherein the building of the glossary comprises:
extracting a proper noun from the at least one webpage; and
adding the extracted proper noun to the glossary.

5. The translation service providing method of claim 1, wherein the building of the glossary comprises:
extracting, from the at least one webpage, a term that satisfies a condition on at least one of appearance frequency and appearance count; and
adding the extracted term to the glossary.

6. The translation service providing method of claim 1, wherein the building of the glossary comprises:
extracting information on a usage language of the user from the at least one webpage; and
adding information on the usage language of the user to the glossary.

7. The translation service providing method of claim 6, wherein at least one of a source language and a target language of translation is determined based on information on the usage language of the user that is included in the glossary.

8. The translation service providing method of claim 1, further comprising:
providing translation from a source language to a target language based on a translation request,
wherein the translation is provided by reflecting the glossary.

9. The translation service providing method of claim 8, wherein unification of terms and priority adjustment of terms used in the target language are performed by reflecting the glossary in a process of providing the translation.

10. The translation service providing method of claim 8, wherein, when the glossary includes a term written in the target language, the term included in the glossary is preferentially reflected in a translation result.

11. The translation service providing method of claim 8, wherein the building of the glossary comprises:
when the at least one webpage includes a page written in a first language and a page written in a second language different from the first language, extracting a first term from the page written in the first language;
extracting a second term corresponding to the first term from the page written in the second language; and
adding the first term and the second term to the glossary by associating the first term with the second term.

12. The translation service providing method of claim 11, wherein, when the first language is set as a source language, a third language is set as a target language, and the second language is set as an intermediate language in a process of providing the translation, a mapping relationship between the first term and the second term is considered in a translation process between the source language and the intermediate language.

13. The translation service providing method of claim 1, further comprising:
performing monitoring on at least one webpage related to the domain information; and
when a change in the at least one webpage related to the domain information is reflected by monitoring, updating the glossary by analyzing the changed content.
